(19) United States
(12) Patent Application Publication
(10) Pub. No.: US 2005/0102338 A1
(43) Pub. Date: May 12, 2005

(54) Signal processing

(76) Inventor: Andrew Thurston, Cambridgeshire (GB)

Correspondence Address: BANNER & WITCOFF, LTD., TEN SOUTH WACKER DRIVE, SUITE 3000, CHICAGO, IL, 60606, US

(21) Appl. No.: 10/433,921

(22) PCT Filed: Dec. 3, 2001
(86) PCT No.: PCT/GB01/05335

(30) Foreign Application Priority Data
Dec. 7, 2000 (GB) 0029874.5

(51) Int. Cl. G06F 17/10

(52) U.S. Cl. 708/300; 708/322

(57) ABSTRACT

A filter (26) is used to average power values of a signal that has been subjected to varying gain. The gain is factorised into two factors, the first being the highest power of 2 within the gain, and the second being a factor which can be multiplied with the first factor to reprodeuce the gain. The power values are divided by the second factor before reaching the filter (26) and by the first factor after passing through the filter (26). The signal values already in the filter (26) are bit-shifted when the exponent in the first changes so that the filter is not disrupted by changes in the gain.

The invention relates to signal processing, and in particular to methods and apparatus for filtering digital signals that have been produced under variable gain conditions.

It is known to amplify a received signal under variable gain conditions. For example, it is known to use automatic gain control in a receiver for the purpose of amplifing a received signal which is fading. A problem is that subsequent signal processing performned on the amplified signal is complicated by the fact that the gain used in the amplification is variable. It is an aim of the present invention to provide simpler signal processing of such signals.

According to one aspect, the invention provides signal processing apparatus for operating on a signal that has been amplified under variable gain, the apparatus comprising a digital filter for filtering the signal values, and adapting means for adapting at least one signal value when the gain changes so as to ameliorate the biasing of the filtering operation by the change in gain.

According to another, and related, aspect, the invention also provides a method of processing a signal that has been amplified under variable gain, comprising digitally filtering the signal values and adapting at least one signal value when the gain changes so as to ameliorate the biasing of the filtering operation by the change in gain.

Hence, the invention provides a more reliable way of applying a desired filtering characteristic to a digital signal.

In a preferred embodiment, the signal values involved in the filtering process are adapted by bit-shifting. Advantageously, this is simpler than generating adapted signal values by arithmetic.

In one embodiment, the variable gain is factored into two factors, the first factor being the highest exponent of two present in the gain and the second factor being such that when multiplied with the first factor, the result is the gain value. Then, the signal values can be divided by the second factor such that the only gain variations present in the signal values are variations in the exponent of the first factor, e.g. variations such as the first factor changing from 2^{m} to 2^{m+1}. Advantageously, the filter need only then be able to cope with variations of this constrained kind. By then bit-shifting the signal values involved in the filtering process, it is possible to render the filtering operation insensitive to gain variations by a factor which is an exponent of two. Preferably, when bit-shifted, a signal value is displaced by a number of binary places corresponding to the numerical change in the exponent of the first factor.

In a preferred embodiment, the filter averages the signal values passing through it. Preferably, this averaging process is a weighted averaging process.

In a preferred embodiment, the filtered signal is a signal representing one of a noise signal and a wanted signal that is to be used for assessing the wanted signal relative to the noise signal (e.g. by calculating the ratio of the power in the wanted signal relative to the power in the noise signal).

By way of example only, an embodiment of the invention will now be described with reference to the accompanying figures, in which:

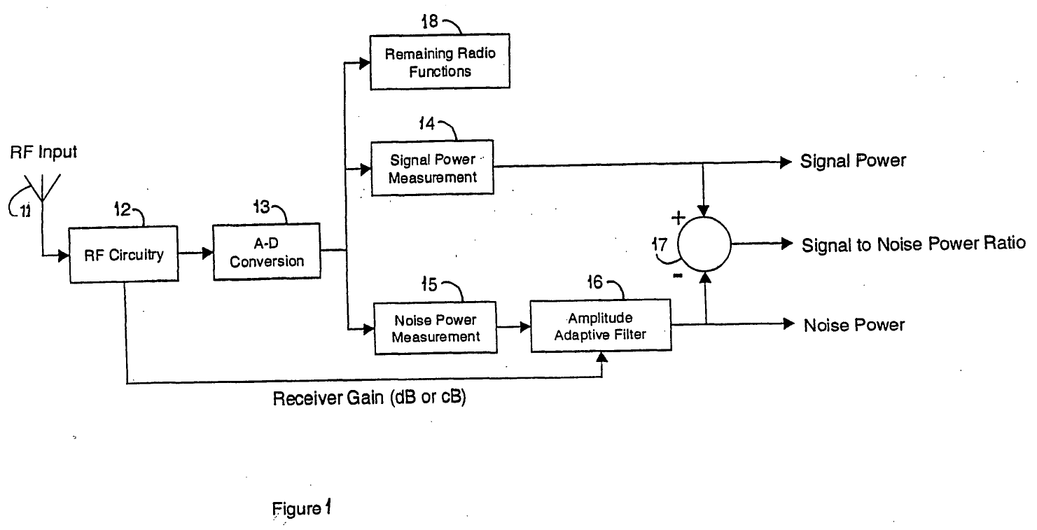

FIG. 1 is a block diagram of a radio receiver; and

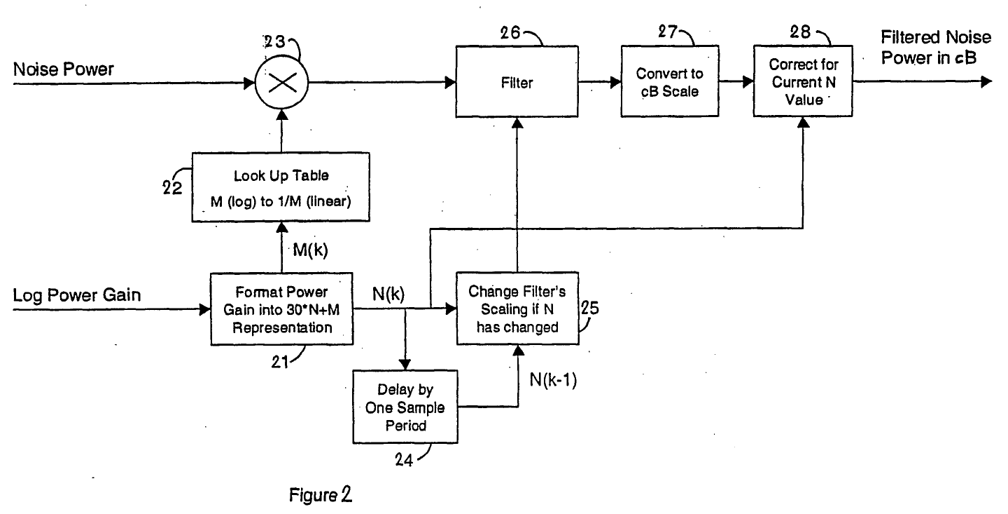

FIG. 2 is a block diagram of the amplitude adaptive filter of FIG. 1.

The radio receiver of FIG. 1 comprises an antenna 11 for receiving transmitted wireless signals. Signals picked up by antenna 11 are supplied to radio frequency circuitry 12 which recovers a signal from amongst the signals received at antenna 11. The recovered signal is passed to A-D converter 13 for conversion to the digital domain. One of the roles of RF circuitry 12 is to amplify the recovered signal. This amplification is done using automatic gain control and accordingly the recovered signal sent to A-D converter 13 has been produced under a varying gain. The gain which the RF circuitry 12 can apply to the recovered signal can adopt one of a plurality of discrete values as directed by the automatic gain control process, which process operates in a known manner.

Downstream of A-D converter 13, the digital version of the recovered signal is supplied to the main processing unit 18 of the radio receiver, where the information contained in the recovered signal is used in its intended way. The radio receiver is also arranged to calculate the signal to noise power ratio of the recovered signal. For this purpose, the digital version of the recovered signal output by A-D converter 13 is supplied to each of a signal power measuring section 14 and to a noise power measuring section 15. The signal power measurement section 14 calculates the power present in a wanted component of the digital version of the recovered signal. The noise power measurement section 15 calculates the power present in an unwanted component (i.e. a noise component) of the digital version of the recovered signal. The wanted component is isolated by a known correlation process and is subtracted from the recovered signal to produce the noise component.

The signal indicative of the measured noise power (from measurement section 15) is supplied to amplitude adaptive filter 16 which averages the noise power signal. The filter 16 has a number of coefficients that serve as the weighting factors used in the averaging process. The amplitude adaptive filter 16 is supplied with the power gain values used in RF circuitry 12 to amplify the recovered signal, and the amplitude adaptive filter 16 uses these gain values (in a manner which will be described in more detail later) to ensure that the averaging process that it performs is not biased by any changes in the gain used to amplify the recovered signal.

The output of filter 16 is a signal indicative of the average power of the noise component. The output of measuring section 14 is a signal indicative of the power in the wanted component of the recovered signal. The signals from section 15 and filter 16 are supplied to subtractor 17 which subtracts the noise power signal from the wanted power signal. This subtraction produces a signal to noise power ratio, since at this stage the signal power signal and the noise power signal each represent the logarithm of measured power so that the action of the subtractor is equivalent to division. The signals indicative of wanted power, noise power and the signal to noise power ratio are supplied to other components of the radio receiver and used in the control of the radio receiver in a known manner.

The construction of the amplitude adaptive filter 16 is illustrated in FIG. 2. The noise power signal, in its raw form, is supplied as a stream of values Pₖ (where k=1, 2, 3 . . . ) from measuring section 15 to an input of multiplier 23. The power gain applied to the recovered signal is supplied in logarithmic format from RF circuitry 12 to formatting unit 21.

The logarithmic signal supplied to formatting unit 21 represents the receiver gain in centibels, cB (10 cB=1 dB). The formatting unit 21 converts the centibel gain G, into a new representation which is the sum of two factors, M and 30N. Accordingly, G=M+30N. To convert the centibel gain into the new representation, the centibel gain G is divided by 30, and the integer part of the result is the value of N. Once N has been determined, M is determined from the equation M=G−30N.

As time progresses, the values, Pₖ, of the noise power signal pass through the amplitude adaptive filter 16, and Pₖ₋₁ is the preceding (in time) value of the noise power signal and Pₖ₊₁ is the succeeding (in time) value of the noise power signal. Accordingly, it is appropriate to apply the same nomenclature to the gain and refer to the logarithmic gain as Gₖ. However, it will be appreciated that Gₖ will only vary relative to a neighbouring gain value (say Gₖ₊₁) if the gain is actually changed by the automatic gain control process in the RF circuitry 12. Similarly, the additive components of the gain representation produced by formatting unit 21 are more properly referred to as Mₖ and Nₖ. Clearly, Mₖ and Nₖ will only change if Gₖ changes. Nₖ will only change when there is a change in the integer part of G÷30. It will be apparent to the reader that each time N increases by one, the linear gain (i.e. 10^{G}^{ₖ}, and not the logarithmic gain Gₖ) changes by a factor of approximately 2, that is, 10^{(30÷100)}≈2. Conversely, decrementing N by 1 leads to a halving of the linear gain.

The value Mₖ from formatting unit 21 is supplied to converter 22 which transforms this component of the gain to a linear value of

$${10}^{( \frac{{M}_{k}}{100} )} .$$

Converter 22 then calculates the inverse of this linear value, i.e.

$${10}^{- ( \frac{{M}_{k}}{100} )} .$$

The value

$${10}^{- ( \frac{{M}_{k}}{100} )}$$

is supplied to the other input of multiplier 23. Accordingly, multiplier 23 divides Pₖ by the linear value corresponding to Mₖ to produce a scaled power value P′ₖ. The variation of the noise power values with changes in the linear gain has only been partially removed in that the linear gain remaining in the power values output by multiplier 23 may still vary by a factor which is an exponent of 2. For example, consider that there is a gain change such that Gₖ is not equal to Gₖ₊₁. If Nₖ=Nₖ₊₁, then the gain residually present in the output of multiplier 23 does not change. If, on the other hand, Nₖ₊₁≠Nₖ, then the residual gain present in P′ₖ₊₁ is a factor of 2^{b} (b is a positive or negative integer) different from the residual gain present in P′ₖ. In summary, it will be seen that variations in the gain have not been eliminated in the output of multiplier 23, but rather the gain in the P′ₖ values has been restricted to take only values with ratios of 2^{N}^{ₖ}.

Returning now to formatting unit 21, the value Nₖ is supplied to a delay unit 24, a comparison unit 25 and to a correction unit 28. The delay unit 24 delays the value of Nₖ for one sample period of the digital signals (i.e. until Nₖ₊₁ is issued by formatting unit 21) and then presents Nₖ to an input of the comparison unit 25. Thus, it will be seen that comparison unit 25 always compares consecutive values of N, e.g. Nₖ and Nₖ₋₁. If the comparison unit detects a change in consecutive values of N, then it instructs a scaling of the signal values of P′ that are already in digital filter 26.

The digital filter 26 performs an averaging operation on the values of P′ received from multiplier 23. Digital filter 26 produces an output P″ₖ in response to an input P′ₖ. P″ₖ is produced by performing a weighted average on a group of consecutive values of P′. The filter coefficients provide the weighting factors in the weighted averaging process performed by filter 26.

Consider now the case where the gain G changes so as to affect N such that Nₖ₊₁−Nₖ=b, where b can take positive or negative integer values.

Upon the filter calculating P″ₖ₊₁, the values of P′ already within the filter 26 will initially need to be multiplied by a factor of 2^{b} (which is diminishing if b is negative) to ensure that the filtering process is not biased by the difference in the residual gain between P′ₖ₊₁ and the P′ values already in the filter. To achieve this multiplication, each of the values of P′ already within the filter are bit-shifted by a number of bits |b| the direction of increasing bit-significance if b is positive or, if b is negative, in the direction of decreasing bit significance. Hence, the modification of the P′ values is achieved without recourse to time consuming arithmetic.

The filtered power values P″ₖ output by filter 26 are converted from linear values to logarithmic values on the centibel scale by scaling unit 27. The centibel P″ₖ, values are then supplied to corrector unit 28 which subtracts Nₖ from P″ₖ, which is equivalent to dividing the linear value corresponding to P″ₖ by the linear gain factor corresponding to Nₖ. The output of corrector unit 28 is a filtered noise power in centibels that is insensitive to changes in the power gain used to amplify the recovered signal in the RF circuitr 12.

Whilst the invention has been described in the context of a signal which is a train of power values, it will be appreciated by the skilled person that the signal values could, equally, represent (for example) the amplitude or level of a signal.

1. Signal processing apparatus for operating on a signal that has been amplified under variable gain, the apparatus comprising a digital filter for filtering signal values, and an adaptor for adapting at least one signal value when the gain changes so as to ameliorate the biasing of the filtering operation by the change in gain.

2. The apparatus according to claim 1, wherein the adaptor is configured to bit-shift said at least one signal value to adapt said at least one signal value.

3. The apparatus according to claim 1, further comprising a calculator for factorising the gain into two factors, the first factor being the highest power of 2 present in the gain and the second factor being such that when multiplied with the first factor the result is the gain value.

4. The apparatus according to claim 3, wherein the adaptor is configured to change said at least one signal value upon detecting a change in the first factor.

5. The apparatus according to claim 4, wherein the adaptor is configured to bit-shift said at least one signal value by a number of bits corresponding to the numerical change in the exponent of the first factor.

6. The apparatus according to claim 3, further comprising a first adjuster that scales the signal values by the second factor before they reach the filter.

7. The apparatus according to claim 3, further comprising a second adjuster that scales the signal values by the first factor after they have passed through the filter.

8. The apparatus according to claim 1, wherein the gain values are logarithmic.

9. The apparatus according to claim 1, wherein the filter is configured to average signal values passing through it.

10. The apparatus according to claim 1, wherein the signal is a noise signal or noise component.

11. The apparatus according to claim 1, further comprising an assessor for assessing a wanted signal relative to a noise signal, wherein the filtered signal values provide one of the wanted signal and the noise signal.

12. A method of processing a signal that has been amplified under variable gain, comprising digitally filtering signal values and adapting at least one signal value when the gain changes so as to ameliorate the biasing of the filtering operation by the change in gain.

13. The method according to claim 12, wherein adapting said at least one signal value comprises bit-shifting said at least one signal value.

14. The method according to claim 12, further comprising factorising the gain into two factors, the first factor being the highest power of 2 present in the gain and the second being such that when multiplied with the first factor the result is the gain.

15. The method according to claim 14, wherein said at least one signal value is changed upon detecting a change in the first factor.

16. The method according to claim 15, wherein changes to the said at least one signal value are implemented by bit-shifting said at least one signal value by a number of bits corresponding to the numerical change in the exponent of first factor.

17. The method according to any one of claim 14, further comprising scaling the signal values by the second factor before they are filtered.

18. The method according to claim 14, further comprising scaling the signal values by the first factor after they have been filtered.

19. The method according to claim 12, wherein the gain is logarithmic.

20. The method according to claim 12, wherein the filtering operation averages the power values.

21. The method according to claim 12, wherein the signal is a noise signal or noise component.

22. The method according to claim 12, comprising assessing a wanted signal relative to a noise signal, wherein the filtered signal values provide one of the wanted signal and the noise signal.

23. A computer-readable medium containing computer-executable instructions for causing a data processing apparatus to perform signal processing on a signal that has been amplified under variable gain, said signal processing comprising the steps of digitally filtering signal values and adapting at least one signal value when the gain changes so as to ameliorate the biasing of the filtering operation by the change in gain.
